(19) United States
(12) Patent Application Publication
(10) Pub. No.: US 2026/0191011 A1
(43) Pub. Date: Jul. 2, 2026

(54) SEMICONDUCTOR DEVICE WITH PHYSICAL UNCLONABLE FUNCTION

(71) Applicant: Winbond Electronics Corp., Taichung City (TW)

(72) Inventors: Chi-Ching LIU, Chiayi County (TW); Ping-Kun WANG, Changhua County (TW); Shun-Li LAN, Taichung City (TW); Ming-Che LIN, Taichung City (TW); He-Hsuan CHAO, Hsinchu City (TW)

(21) Appl. No.: 19/437,004

(22) Filed: Dec. 30, 2025

(30) Foreign Application Priority Data
Dec. 30, 2024 (TW) 113151403

(51) Int. Cl. H10W 42/40; H04L 9/32; H10W 20/42; H10W 20/43

(52) U.S. Cl. CPC H10W 42/405; H04L 9/3278; H10W 20/42; H10W 20/43

(57) ABSTRACT

A semiconductor device with a physical unclonable function includes: a substrate; a physical unclonable function (PUF) structure; and a logic circuit configured to determine a logical value of the PUF structure and operate the logical value to generate a random number. The PUF structure includes: a first conductive layer over the substrate; an insulating layer on the first conductive layer; a second conductive layer on the insulating layer; and a conductive via penetrating the insulating layer and connecting the second conductive layer and the first conductive layer.

### CROSS REFERENCE TO RELATED APPLICATIONS

This application claims priority of Taiwan Patent Application No. 113151403, filed Dec. 30, 2024, the entirety of which is incorporated by reference herein.

### TECHNICAL FIELD

The present disclosure relates to a semiconductor device, and in particular, to a semiconductor device with physical unclonable function (PUF).

### BACKGROUND

The physical unclonable function (PUF) is a physical entity existing in a physical structure. For a given input and condition (challenge), the PUF provides the physically defined “digital fingerprint” output (response) as a unique authentication mark. The PUF is commonly applied in the semiconductor device (such as microprocessors), and can usually be considered a unique physical transformation that occurs spontaneously in the semiconductor manufacturing process. In other words, the PUF depends on the uniqueness of its physical microstructure, which depends on random physical factors being introduced during the manufacturing process. Such random physical factors are unpredictable and uncontrollable, thus it is virtually impossible to replicate the microstructure of the PUF. Furthermore, the microstructure of the PUF can be assessed through implementing the challenge-response authentication. Therefore, there are different types of the PUF designs being utilized in various applications with higher security requirements. Nevertheless, several challenges remain with current physical unclonable functions, including structural complexity—such as the requirement to manufacture numerous transistors—difficulty in resistance control, and increased costs.

### BRIEF SUMMARY

The present disclosure proposes a semiconductor device with a physical unclonable function to resolve or mitigate the drawbacks found in the existing technology.

An embodiment of the present disclosure provides a semiconductor device with a PUF includes: a substrate; a PUF structure; and a logic circuit configured to determine a logical value of the PUF structure and operate the logical value to generate a random number. The PUF structure includes: a first conductive layer over the substrate; an insulating layer on the first conductive layer; a second conductive layer on the insulating layer; and a conductive via penetrating the insulating layer and connecting the second conductive layer and the first conductive layer.

The semiconductor device with the PUF of the present disclosure allows easy control of resistivity and offers benefits in both scaling and cost reduction.

### BRIEF DESCRIPTION OF THE DRAWINGS

FIG. 1 is a schematic view of a semiconductor device, according to some embodiments of the present disclosure;

FIG. 2 is an enlarged view of a portion of the die regions of the semiconductor device in FIG. 1;

FIG. 3 is a cross-sectional view of a PUF structure in two neighboring die regions of a semiconductor device, according to some embodiments of the present disclosure;

FIG. 4 is a schematic view of a first conductive layer connected to conductive vias of a PUF structure of a wafer during the spinning process, according to some embodiments of the present disclosure;

FIGS. 5A-5D are partial cross-sectional views of a PUF structure at some intermediate stages, according to some embodiments of the present disclosure;

FIG. 6 is a simplified view of a PUF structure and electronic elements in two neighboring die regions of a semiconductor device, according to some embodiments of the present disclosure;

FIG. 7 is a plot of a resistance distribution of PUF structures of a semiconductor device, according to some embodiments of the present disclosure;

FIG. 8 is a schematic view of logical values of PUF structures in two semiconductor chips, according to some embodiments of the present disclosure;

FIG. 9 illustrates a block diagram of a semiconductor device including a PUF array and a logic circuit, according to some embodiments of the present disclosure;

FIG. 10 illustrates a block diagram of applying a semiconductor device, according to some embodiments of the present disclosure; and

FIG. 11 is a partial cross-sectional view of a semiconductor chip at an intermediate stage, according to some embodiments of the present disclosure.

### DETAILED DESCRIPTION

The following disclosure can be more fully understood by reading the subsequent detailed description and examples with references made to the accompanying drawings. However, the present disclosure may be present in different manners, and should not be limited to the embodiments described throughout the context. Furthermore, the semiconductor device referred to by the present disclosure may be a wafer, a chip, or a die in different embodiments.

A semiconductor device 1 (for example, a silicon wafer) has die regions A_{D} and scribe line regions LS between the die regions A_{D}, as shown in FIG. 1. Each die region A_{D} includes one or more dies 11 that are functionally similar or different. The scribe line regions LS include first scribe lines LS1 extending along a first direction D1 (for example, x-axis direction) and second scribe lines LS2 extending along a second direction D2 (for example, y-axis direction). The second direction D2 is, for example, perpendicular to the first direction D1, but the present disclosure is not limited thereto. The arrangement and size of the die regions A_{D}, as well as the number of dies 11, are provided for illustration only and should not be considered limiting.

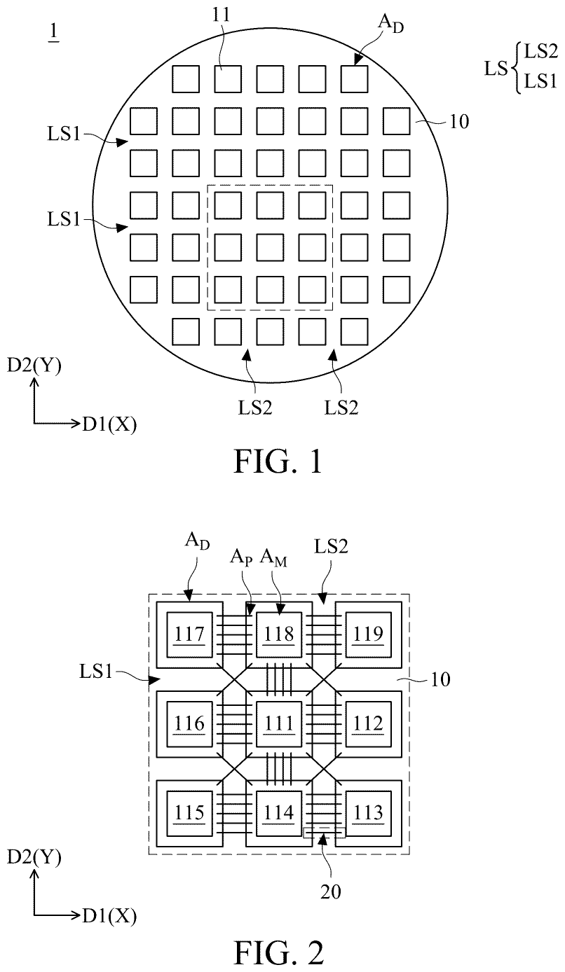

FIG. 2 is an enlarged view of a portion of die regions of the semiconductor device in FIG. 1. In the present example, 9 neighboring die regions A_{D} are illustrated. Dies 111, 112, 113, 114, 115, 116, 117, 118, 119 are disposed within the corresponding die regions A_{D}, respectively. Each die 11 includes a PUF structure 20, and each PUF structure 20 includes a conductive line connected across two neighboring dies.

For a distinct die, the end portions of the PUF structures 20 may be arranged in the die regions A_{D}, for example, arranged in a portion or an entirety of a peripheral region A_{P} surrounding a memory region A_{M} of each die region A_{D}. The end portions of the PUF structures 20 may be scattered in a surrounding manner in the die regions A_{D}, as shown In FIG. 2. The end portions of the PUF structures 20 may be arranged into one or more columns, one or more rows, matrix arrays, or the like in the die regions A_{D}. Moreover, the connected directions of the PUF structures 20 are not specifically limited, and may be parallel to, perpendicular to, and/or diagonally with respect to the extending direction of the scribe line regions LS.

For example, the die 111 includes some PUF structures 20 parallel to the extending direction of the first scribe lines LS1. The conductive lines (for example, a first conductive layer 21) of such PUF structures 20 may be connected across neighboring die 111 and die 112, and may be connected across neighboring die 111 and die 116. The die 111 further includes some PUF structures 20 that are perpendicular to the extending direction of the first scribe lines LS1. The conductive lines of such PUF structures 20 may be connected across neighboring die 111 and die 114, and may be connected across neighboring die 111 and die 118. The die 111 further includes some PUF structures 20 that are diagonal with respect to the extending direction of the first scribe lines LS1. The conductive lines of such PUF structures 20 may be connected across neighboring die 113, die 115, die 117, and die 119. The quantity and the arrangement of the PUF structures 20 shown in FIG. 2 are illustrative only, and may be varied and determined according to actual applications.

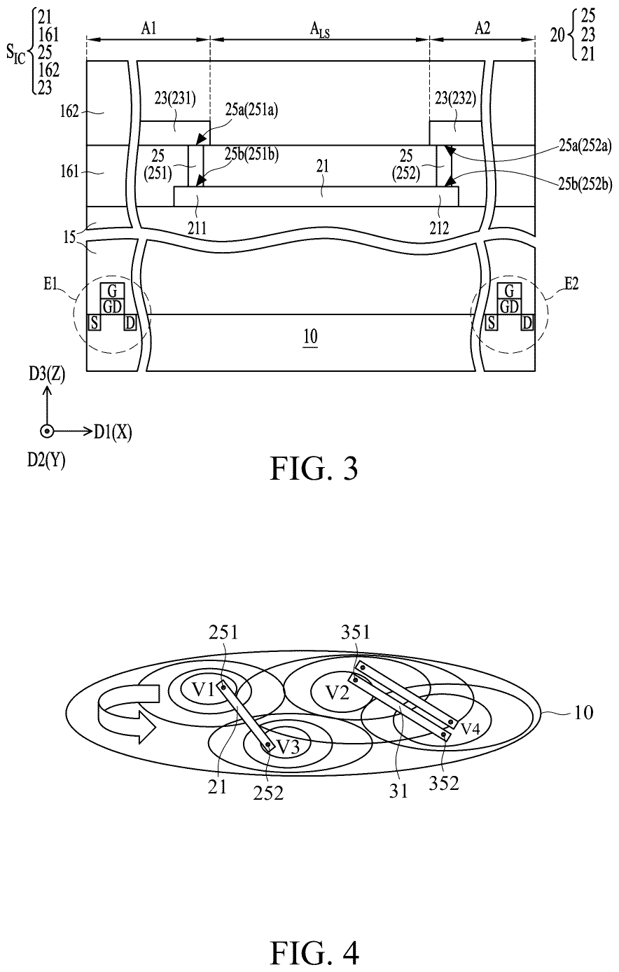

The related description of the associated elements and the arrangement of a single PUF structure 20 is proposed in the following embodiments. FIG. 3 is an enlarged cross-sectional view of the selected block in FIG. 2. Reference can be made simultaneously to FIG. 2 and FIG. 3.

According to some embodiments, the die 11 includes PUF structures 20 and logic circuits. Each PUF structure 20 includes the first conductive layer 21 over the substrate 10, an insulating layer 161 on the first conductive layer 21, a second conductive layer 23 on the insulating layer 161, and a conductive via 25 penetrating the insulating layer 161 and connecting the second conductive layer 23 and the first conductive layer 21. A top surface 25a and a bottom surface 25b of the conductive via 25 are in contact with the second conductive layer 23 and the first conductive layer 21, respectively. If the insulating layer 161 is a multi-layer insulating layer, then the conductive via 25 may be a stepped conductive via. The insulating layer 161 is shown as a single-layer insulating layer in this embodiment. Furthermore, an additional insulating layer 162 may be formed over the insulating layer 161 to cover the second conductive layer 23.

FIG. 3 illustrates two neighboring first die region A1 and second die region A2, and a scribe line region A_{LS} between the first die region A1 and the second die region A2. The first conductive layer 21 of the PUF structure 20 spans across the scribe line region A_{LS}, and electrically connects two different conductive vias 25 (for example, a conductive via 251 and a conductive via 252) in the first die region A1 and the second die region A2.

In some embodiments, the die in the first die region A1 includes a first end portion 211 of the first conductive layer 21, a second conductive layer 231 over the first conductive layer 21, and the conductive via 251 penetrating the insulating layer 161 and connecting the second conductive layer 231 and the first conductive layer 21. The conductive via 251 and the second conductive layer 231 are within the first die region A1. The conductive via 251 is, for example, perpendicular to the second conductive layer 231 and the first conductive layer 21. A top surface 251a and a bottom surface 251b of the conductive via 251 are in contact with the second conductive layer 231 and the first conductive layer 21, respectively. The first conductive layer 21 has the first end portion 211 and a second end portion 212 opposite from each other. The first end portion 211 is in the first die region A1, and may be electrically connected with the overlying second conductive layer 231 through the conductive via 251. Moreover, the first conductive layer 21 spans across the scribe line region A_{LS}, allowing the second end portion 212 of the first conductive layer 21 to be in the second die region A2.

In other words, a portion of the first conductive layer 21 (for example, the first end portion 211) lies in the vertical projection of the first die region A1, while another portion of the first conductive layer 21 (for example, the second end portion 212) lies in the vertical projection of the second die region A2, in some embodiments. The central portion of the first conductive layer 21 lies in the vertical projection of the scribe line region A_{LS}.

Similarly, the die in the second die region A2 includes the first conductive layer 21, a second conductive layer 232 over the first conductive layer 21, and the conductive via 252 penetrating the insulating layer 161 and connecting the second conductive layer 232 and the first conductive layer 21. The conductive via 252 and the second conductive layer 232 are within the second die region A2. The conductive via 252 is, for example, perpendicular to the second conductive layer 232 and the first conductive layer 21. A top surface 252a and a bottom surface 252b of the conductive via 252 are in contact with the second conductive layer 232 and the first conductive layer 21, respectively. The second end portion 212 of the first conductive layer 21 is in the second die region A2, and may be electrically connected with the overlying second conductive layer 232 through the conductive via 252.

Accordingly, the conductive via 251 and the conductive via 252 in two different die regions may be electrically connected through the first conductive layer 21. During the wafer-level manufacturing stage, the first conductive layer 21 of each PUF structure 20 may connect across the dies from two neighboring die regions.

Moreover, the die may further include an interconnection structure S_{IC} formed over the substrate 10, for example, over an insulating layer 15. The insulating layer 15 covers one or more electronic elements on the substrate 10, for example, covering an electronic element E1 in the first die region A1 and an electronic element E2 in the second die region A2. Moreover, the interconnection structure S_{IC} includes, for example, a stack of metal layers and insulating layers between the metal layers (for example inter-metal dielectric (IMD) layers). The metal layers are electrically connected through connectors in the insulating layers. In the present embodiment, the interconnection structure S_{IC} includes the first conductive layer 21, the second conductive layer 23, the conductive via 25, the insulating layers 161 and 162. In some embodiments, the interconnection structure S_{IC} is over and electrically connected with the electronic elements E1 and E2, to provide intra-region interconnections to the electronic elements E1 and E2. The electronic elements E1 and E2 are, for example, transistors, diodes, or any other suitable components.

FIG. 3 depicts the electronic elements E1 and E2, which are transistors. Each transistor includes a gate G, a gate dielectric layer GD between the gate G and the substrate 10, and a source S and a drain D respectively on opposite sides of the gate G in the substrate 10. The electronic elements E1 and E2 may also be other structural configurations and/or integrated circuits (IC) with higher quantity.

In some embodiments, the first conductive layer 21, the second conductive layer 23, and the conductive via 25 of the PUF structure 20 may be formed in the interconnection structure S_{IC}, saving substrate 10 space to aid device scaling. Furthermore, the first conductive layer 21 and the second conductive layer 23 may respectively constitute a conductive line and a pad, but the present disclosure is not limited thereto.

According to some embodiments, the PUF structures 20 may exhibit different physical characteristics (for example, having different resistance) during the manufacturing process, in order to provide the PUF of the resulting devices (for example, chips).

During the manufacturing process of the semiconductor device, for example, at the wafer-level fabrication stage, certain steps may affect the formation of the conductive vias 25, resulting in conductive vias 25 having different physical states. For instance, the bottom surface and/or the top surface of the conductive vias 25 may include an oxide, thereby causing the conductive vias 25 of the PUF structures 20 to exhibit different resistance values. The logical values of the PUF structures 20 may be determined through the logic circuits according to the resistance differences of the conductive vias 25. Also, the logic circuits may perform related operations on these logical values and generate random numbers to provide the physical unclonable function of the device (for example, the chip) in the embodiments.

As shown in FIG. 4, some process may be performed while the wafer is in a rotating state (as indicated by the arrow) may cause defects in the conductive vias 25. An example principle that may lead to defects in the conductive vias 25 is described below; however, the present disclosure is not limited thereto.

According to some embodiments, the first conductive layer 21 of the PUF structure may connect the conductive vias 251 and 252 located in different die regions. A first conductive layer 31 of another PUF structure may connect conductive vias 351 and 352 in different die regions. When processes such as wet cleaning (which may include a combination of one or more chemicals and deionized (DI) water), or the chemical mechanical polishing (CMP) or grinding (which includes slurry having abrasive particles) are performed while the substrate 10 is in a rotating state, electrostatic charges may naturally accumulate on the first conductive layers 21 and 31. This results in different voltages V1 and V3 at the two ends of the first conductive layer 21 and different voltages V2 and V4 at the two ends of the first conductive layer 31, thereby inducing relatively strong currents through the first conductive layers 21 and 31. Consequently, defects may form at the conductive via 251 and/or the conductive via 252, and the conductive via 351 and/or the conductive via 352, such as the generation of metal oxides, which damage the conductive via and cause variations in the resistance of the conductive via.

Moreover, the longer the length of the first conductive layer in the PUF structure the embodiment, the greater the likelihood of causing significant damage to the conductive via during the manufacturing process. For example, the first conductive layer 31 of FIG. 4 is longer than the first conductive layer 21; therefore, when the substrate 10 undergoes processes such as wet cleaning or CMP while in a rotating state, more electrostatic charge tends to accumulate on the first conductive layer 31. This results in a larger voltage difference between the two ends of the first conductive layer 31 (for example, (V4-V2)>(V1-V3)), thereby inducing a stronger currents through the first conductive layer 31. Consequently, greater defects may form at the conductive via 351 and/or the conductive via 352, such as increased formation of metal oxides, which affects the resistance of the conductive vias. The resistance of the conductive via 351 and/or the conductive via 352 may, for example, be higher than that of the conductive via 251 and/or the conductive via 252.

Since the defects in the conductive via 25 are naturally induced during the process and cannot be controlled, each substrate 10, different dies on the same substrate 10, and different PUF structures on the same die may exhibit varying degrees of defects, such as oxides, at the conductive via 25. These oxides cannot be precisely reproduced and exhibit slight differences at the microscopic structural level. Therefore, the conductive vias of the PUF structure at different locations may have different resistance values.

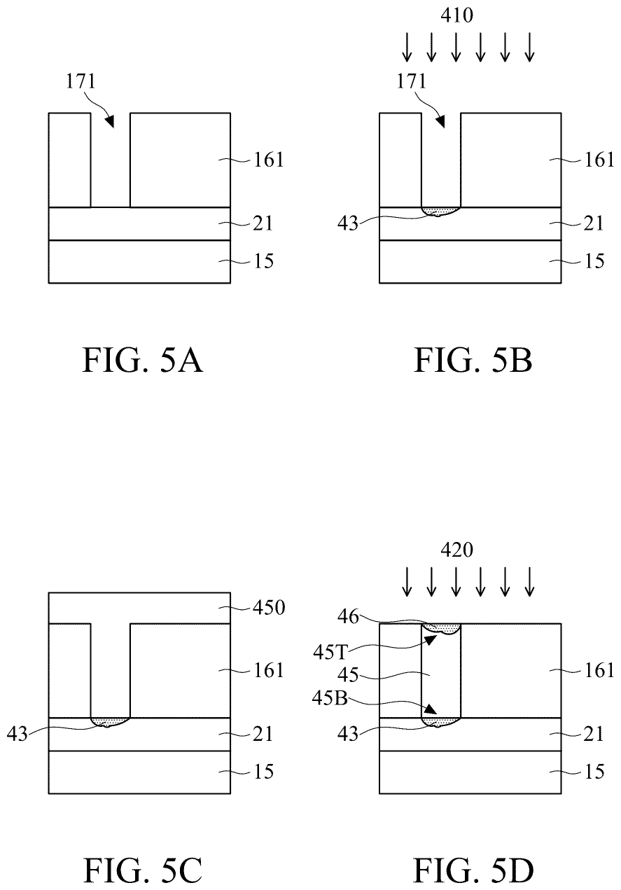

FIGS. 5A-5D are partial cross-sectional views of a PUF structure at intermediate stages, according to some embodiments of the present disclosure. The same or similar elements in FIGS. 5A-5D and in FIG. 3 use the same or similar reference numerals or letters. Reference can be made simultaneously to FIGS. 3, 4, and 5A-5D.

Referring to FIG. 5A, an insulating layer 161 is deposited on the first conductive layer 21 after the first conductive layer 21 is formed on the insulating layer 15, according to some embodiments. The configuration of these layers and elements may be referred to the description of FIG. 3. After that, a trench 171 may be formed in the insulating layer 161 by a suitable patterning process. The trench 171 can pass through the insulating layer 161, exposing part of the top surface of the first conductive layer 21. For simplicity of FIGS. 5A-5D, the illustration of the first conductive layer 21 connecting across two die regions, as well as the elements below the insulating layer 15, are omitted. Only a portion of the first conductive layer 21 associated with the conductive via is illustrated for clarity.

Next, referring to FIG. 5B, after the trench 171 is formed, a clearing process 410 performed to remove residues. During this cleaning process 410, the portion of the first conductive layer 21 exposed within the trench 171 may undergo oxidation, thereby forming a first oxide 43 at the bottom of the trench 171. The first oxide 43 comprises an oxide of the first conductive layer 21, for example, a metal oxide.

Next, referring to FIG. 5C, a conductive material 450 may be deposited over the insulating layer 161 to fill the trench 171. The conductive material 450 may be excessively deposited beyond the top surface of the insulating layer 161. The conductive material 450 includes, for example, metals, alloys, or another suitable conductive material. The conductive material 450 and the first conductive layer 21 include, for example, different conductive materials. Moreover, the conductive material 450 may be formed by physical vapor deposition (PVD), chemical vapor deposition (CVD), another suitable process, or a combination thereof.

Subsequently, referring to FIG. 5D, a portion of the conductive material 450 may be removed by a planarization process 420, for example, chemical mechanical polish process, grinding process, etching process, or a combination thereof. The remaining portion of the conductive material 450 fills the trench 171 to form the conductive via 45. During the planarization process 420, the conductive material 450 may undergo oxidation, resulting in the formation of a second oxide 46 at the top portion 45T of the conductive via 45. The second oxide 46 comprises an oxide of the conductive material 450 of the conductive via 45, for example, a metal oxide.

Moreover, the material of the second oxide 46 differs from that of the first oxide 43. The first oxide 43 may include an oxide of titanium nitride (TiN), titanium (Ti), or a combination thereof, while the second oxide 46 may include an oxide of tungsten (W).

It is noteworthy that the content and/or morphology of the first oxide 43 at bottom portion of different conductive vias may vary, and likewise, the content and/or morphology of the second oxide 46 at the top portion of different conductive vias may also vary. The presence of the oxides affects the resistance of the conductive vias. The conductive vias of the PUF structures at different locations may have different resistance values.

Based on the variation in the resistance values of the conductive vias of the PUF structures at different locations, the logical values of the PUF structures may first be determined through the logic circuits. Subsequently, operations (such as one or more of addition, subtraction, multiplication, division, or other suitable computational methods) may be performed on the determined logical values. A random number may then be generated according to the result of these operations, thereby providing a physically unclonable function for the manufactured products (for example, chips).

In some embodiments, the logic circuits include logic determination circuits and logic operation circuits, where the logic determination circuits determine the logical values of the aforementioned PUF structures. The logic determination circuits are electrically connected to the logic operation circuits. The logic operation circuits operate the determined logical values and generate the random numbers. Moreover, the logic determination circuits are, for example, transistors, diodes, or the like.

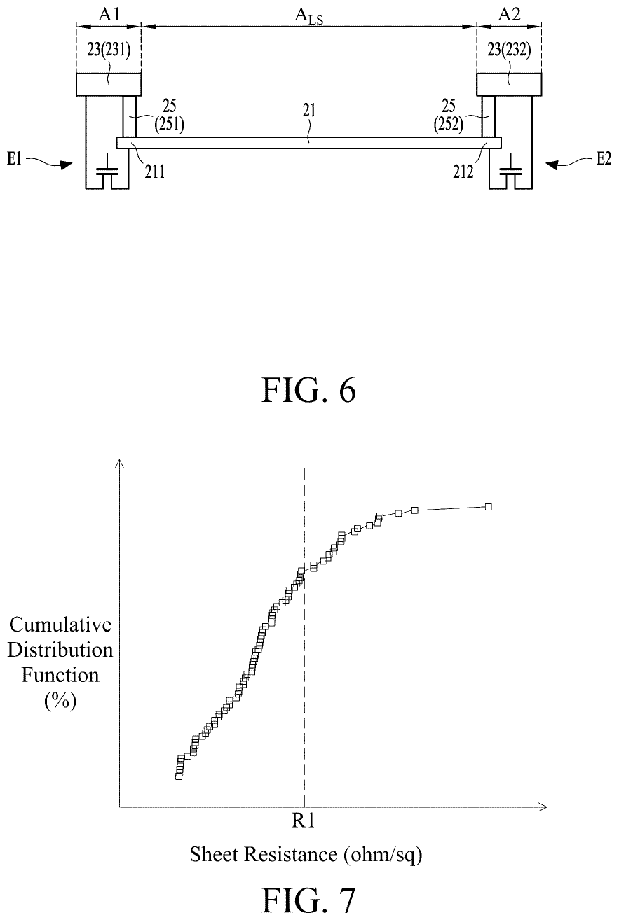

FIG. 6 is a simplified view of a PUF structure and electronic elements in two neighboring die regions of a semiconductor device, according to some embodiments of the present disclosure. The elements other than the first conductive layer 21, the second conductive layer 23 (including the second conductive layers 231 and 232), and the conductive via 25 (including the conductive vias 251 and 252) are omitted in FIG. 6, for simplicity. Moreover, the same elements in FIG. 6 and in FIG. 3 use the same reference numerals or letters, and the details are not described again herein to avoid repetition.

As shown in FIG. 6, the electronic elements E1 and E2 are respectively located in the first die region A1 and the second die region A2. In the first die region A1, the first end portion 211 of the first conductive layer 21 and the second conductive layer 231 are electrically connected to the electronic element E1. Similarly, in the second die region A2, the second end portion 212 of the first conductive layer 21 and the second conductive layer 232 are electrically connected to the electronic element E2. The electronic elements E1 and E2 may be transistors that include the logic determination circuits for determining the logical values of the aforementioned PUF structures. Moreover, the logic determination circuits of the electronic elements E1 and E2 are also coupled to the logic operation circuits (not shown) to operate the logical values of the PUF structures and generate the random numbers, according to some embodiments.

Furthermore, it is worth noted that although the above embodiments illustrate examples in which each PUF structure is connected to a respective electronic element (for example, the transistor including the logic determination circuit), the present disclosure is not limited thereto. In one embodiment, the second conductive layer 231 of the PUF structure is electrically connected to the electronic element E1 including the logic determination circuit, while the second conductive layer 232 of another PUF structure is electrically connected to the electronic element E2 including the other logic determination circuit, thereby enabling rapid the determination of the logical values. In other embodiments, one electronic element may be coupled to multiple PUF structures to determine at least one logical value.

FIG. 7 is schematic diagram illustrating the resistance distribution of multiple PUF structures in a semiconductor device according to some embodiments of the present disclosure. In FIG. 7, the horizontal axis represents the measured resistance of the first conductive layer 21 of the PUF structure, indicated by sheet resistance (Rs, ohm/sq), while the vertical axis represents the cumulative distribution function (CDF), indicated by percentage. Since the sheet resistance of the first conductive layer 21 is affected by the oxides formed in the conductive via, variations in the oxides within the conductive via may also result in differences in the sheet resistance of the first conductive layer 21. Therefore, the sheet resistance of the first conductive layer 21 may be measured as a proxy for the resistance of the conductive via to determine the relative resistance level of the corresponding conductive via.

Based on the curve shown in FIG. 7, these PUF structures exhibit distinguishable resistance values. In some embodiments, after obtaining the resistance values of the PUF structures, a threshold value R1 is set to differentiate between high resistance and low resistance. For example, the logic determination circuit may compare the resistance value of the PUF structure with the threshold value R1. PUF structures with resistance greater than the threshold value R1 are categorized as high resistance, and these are assigned a logical value of “1” by the logic determination circuits. Conversely, PUF structures with resistance less than the threshold value R1 are classified as low resistance, and their resistance is interpreted as a logical value of “0” by the logic determination circuits. Based on the determination of these logical values, a PUF configuration comprising logical values “0” and “1” may be generated, such as a PUF array.

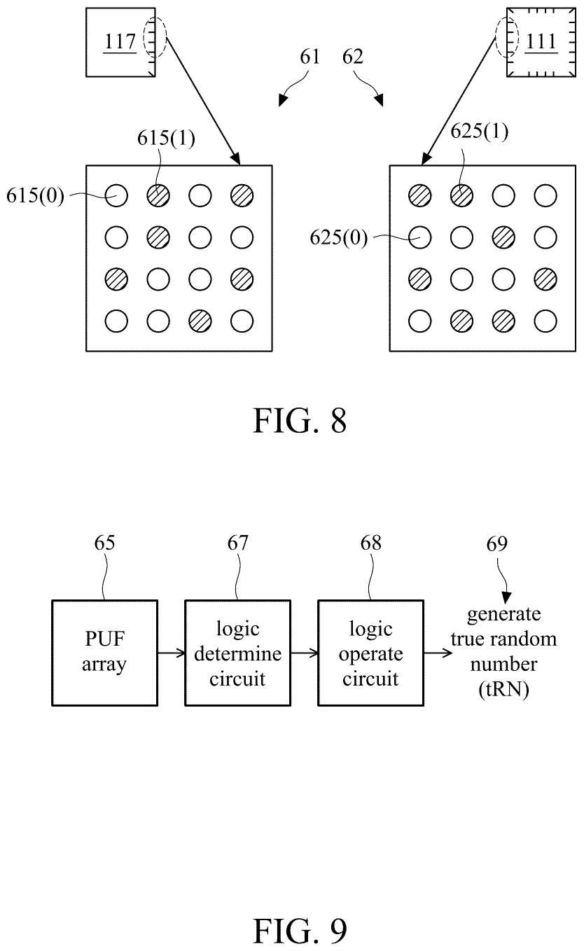

According to some embodiments of the present disclosure, the dies formed from the wafer singulation may be packaged into chips, as shown in FIG. 8. For example, the die 117 may be packaged into a semiconductor chip 61, while the die 111 may be packaged into a semiconductor chip 62. The conductive vias 615 and the conductive vias 625 of the PUF structures are configured into matrix arrays on the semiconductor chip 61 and the semiconductor chip 62, respectively. The present disclosure does not limit the quantity of the dies included in each chip.

Among the conductive vias 615 of the semiconductor chip 61 and the conductive vias 625 of the semiconductor chip 62, the conductive vias 615(1) and the conductive vias 625(1) have high resistance and are indicated by dash lines, which are determined as the logical values of “1” by the logic determination circuits. On the contrary, the conductive vias 615(0) and the conductive vias 625(0) have low resistance and are indicated by blank pattern, which are determined as the logical values of “0” by the logic determination circuits.

The combined pattern having the logical values of “0” and “1” of the conductive vias 615 of the PUF structures in the semiconductor chip 61 may be different from the combined pattern having the logical values of “0” and “1” of the conductive vias 625 of the PUF structures in semiconductor chip 62. The combined patterns having the logical values of “0” and “1” can function as the fingerprint authentication for the semiconductor chip 61 and the semiconductor chip 62. Furthermore, even though the conductive vias of the PUF structures are configured into the matrix array as illustrated in FIG. 8, the conductive vias of the PUF structures may also be arranged into a single row or column, multiple rows or columns alternately arranged, one or more rings (for example, in the peripheral region AP of each die region, as shown in FIG. 2), or the like. Moreover, the number of the PUF structures or the conductive vias in the embodiment is not particularly limited. A greater number of PUF structures/conductive vias allows for the generation of more combinations of random numbers, thereby enhancing the security of the chip.

As shown in FIG. 9, the semiconductor device 1 (for example, the chip) includes a block diagram of a PUF array and a logic circuit, in some embodiments of the present disclosure. The conductive vias connected by the first conductive layer of each PUF structure manufactured by the embodiment may be configured into, for example, a matrix array, which may be referred to as a PUF array 65. The logic circuits may include a logic determination circuit 67 and a logic operation circuit 68. The PUF array 65 is connected to the logic determination circuit 67. For example, the top metal layer (for example, the second conductive layer) of the PUF structure in the embodiment is connected to a transistor, which may provide the logic determination circuit 67 for determining the logical values of the PUF array 65. The logic determination circuit 67 is electrically connected to the logic operation circuit 68. The logic operation circuit 68 performs operations on the determined logical values and generates a true random number (tRN) 69.

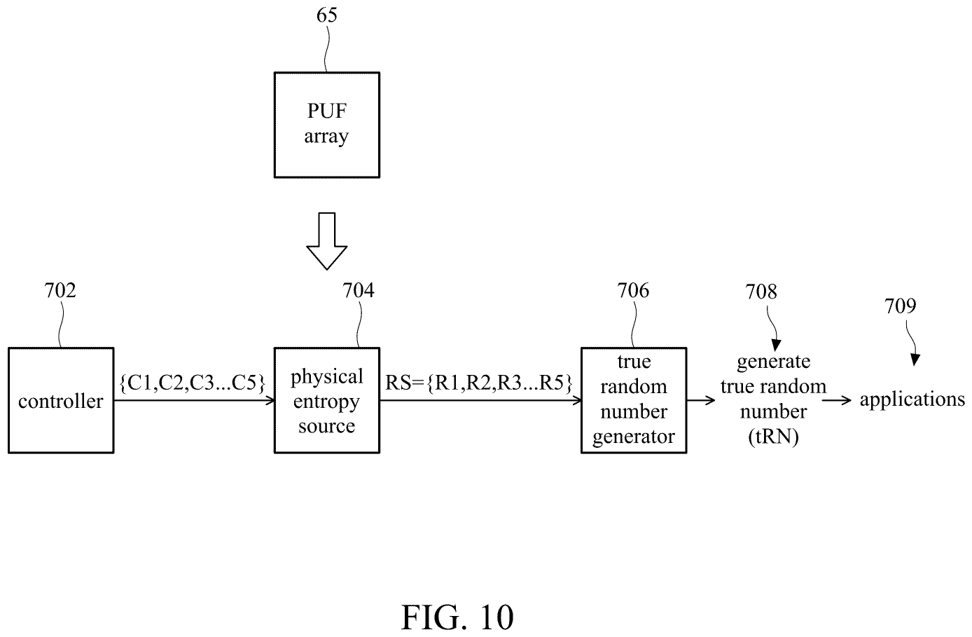

FIG. 10 illustrates a block diagram of an application of a semiconductor device according to some embodiments of the present disclosure. The electrical measurement of the PUF array 65 may provide a physical entropy source 704, for example, a static entropy source. Subsequently, the measurement results of the PUF array 65 are transmitted to a true random number generator (TRNG) 706 to perform logical value determination and computation, thereby obtaining a dynamic entropy source and generating a true random number 708.

During manufacturing, the PUF structures may undergo a series of different “challenges”, and the “responses” thereof are recorded. Through such practice, the unique response of each PUF structure to a given challenge may be identified, and the information may be used to prevent counterfeiting, create and store encryption keys, and enable other security functions. As shown in FIG. 10, a controller 702 may issue a series of challenges (for example, {C1, C2, C3, . . . C5}) to the physical entropy source 704, and the corresponding responses (for example, {R1, R2, R3, . . . R5}) are transmitted to the true random number generator 706 and recorded. Subsequently, as described above, the true random number 708 is generated. The generated true random number 708 may be used to perform various applications 709, such as serving as an encryption key or for other hardware security purposes.

Furthermore, the semiconductor device may include the memory region A_{M} and the peripheral region A_{P} located outside the memory region A_{M}, in some embodiments. In this way, a PUF structural design based on the computer-integrated manufacturing (CIM) technology may be used to integrate the PUF storage and computation functions within the memory, thereby achieving high-speed and low-power PUF computation. In addition, encryption algorithms based on CIM may be utilized to ensure the security and reliability of the PUF computation results.

After completing the manufacturing process of the semiconductor device on the wafer, the wafer is diced, for example, along the first scribe lines LS1 and the second scribe lines LS2 shown in FIG. 1. The diced dies may then undergo further manufacturing to form the semiconductor chip.

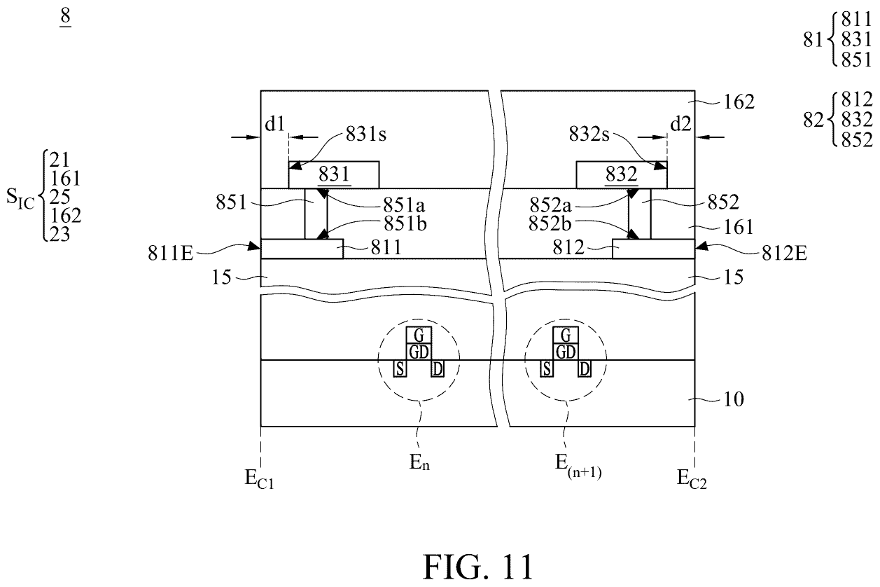

FIG. 11 is a partial cross-sectional view of a semiconductor chip at an intermediate stage, according to some embodiments of the present disclosure. The same or similar elements in FIG. 11 and in FIG. 3 use the same or similar reference numerals or letters, and the details are not described again herein to avoid repetition. Reference can be made simultaneously to FIGS. 3 and 11. After wafer dicing, the bottom metal line originally connecting across two neighboring die regions (for example, the first conductive layer 21 bridging the first die region A1 and the second die region A2 in FIG. 3) is severed, and the remaining portion of the bottom metal line has a side edge substantially flush with the side edge of the substrate.

Moreover, the conductive vias of the PUF structures in a single chip may be distributed in the peripheral region A_{P} of the chip, for example, at the end portions of the PUF structures 20.

As shown in FIG. 11, a semiconductor chip 8 may have a PUF structure 81 and a PUF structure 82. The PUF structure 81 and the PUF structure 82 may be, for example, formed in the interconnection structure S_{IC} over the substrate 10. The substrate 10 includes a first side edge E_{C1} and a second side edge E_{C2} opposite from each other. The PUF structure 81 may be adjacent to the first side edge E_{C1}, while the PUF structure 82 may be adjacent to the second side edge E_{C2}.

The PUF structure 81 includes a first conductive layer 811 over the substrate 10, an insulating layer 161 on the first conductive layer 811, a second conductive layer 831 on the insulating layer 161, and a conductive via 851 penetrating the insulating layer 161 and connecting the second conductive layer 831 and the first conductive layer 811. A top surface 851a and a bottom surface 851b of the conductive via 851 may be in contact with the second conductive layer 831 and the first conductive layer 811, respectively. The first conductive layer 811 and the second conductive layer 831 of the PUF structure 81 may be manufactured by any two metal layers in the interconnection structure S_{IC}.

Since the side edge of the substrate 10 is diced along the scribe lines of the wafer, the original portion of the first conductive layer 811 beyond the die region may be removed as well. As a result, the remaining side edge 811E of the first conductive layer 811 may be substantially coplanar with the first side edge E_{C1} of the substrate 10. The second conductive layer 831 may be extended in the direction away from the first side edge E_{C1}. As shown in FIG. 11, a sidewall 831s is spaced apart from the first side edge E_{C1} by a distance d1 without being in contact.

Moreover, the semiconductor chip 8 further includes logic circuits. Each logic circuit includes a logic determination circuit (not shown) to determine the logical values of one or more PUF structures, and a logic operation circuit (not shown) to operate one or more PUF structures. In one embodiment, the second conductive layer 831 of the PUF structure 81 may be electrically connected to the logic determination circuit to determine the logical values of the PUF structure 81. The logic operation circuit may be coupled to the logic determination circuit to operate the logical values and generate the random number based on the operating result of the logical values.

Similarly, the PUF structure 82 includes a first conductive layer 812, the insulating layer 161, a second conductive layer 832, and a conductive via 852 penetrating the insulating layer 161 and connecting the second conductive layer 832 and the first conductive layer 812. A top surface 852a and a bottom surface 852b of the conductive via 852 may be in contact with the second conductive layer 832 and the first conductive layer 812, respectively. The first conductive layer 812 and the second conductive layer 832 may be manufactured by any two metal layers in the interconnection structure S_{IC}. Moreover, a side edge 812E of the first conductive layer 812 may be substantially coplanar (for example, levelled) with the second side edge E_{C2} of the substrate 10. The second conductive layer 832 may be extended in the direction away from the second side edge E_{C2}. A sidewall 832s is spaced apart from the second side edge E_{C2} by a distance d2 without being in contact. In addition, the PUF structure 82 may be further electrically connected to the logic determination circuit (for example, by the second conductive layer 832), and the logic determination circuit may be electrically connected to the logic operation circuit (not shown in FIG. 11, refer to FIG. 9).

As shown in FIG. 11, the semiconductor chip 8 further includes an electronic element Eₙ and an electronic element E₍ₙ₊₁₎ (for example, transistors) that are electrically connected with the PUF structure 81 and the PUF structure 82, respectively. The transistors include the logic determination circuit to determine the logical values of the PUF structures, and the determined logical values may then be transmitted to the logic operation circuit, in order to operate the logical values and generate the random number.

Moreover, during the wafer-level manufacturing process of the PUF structure 20, one or both of the top portion and the bottom portion of the conductive vias may form oxides, according to an embodiment. Because oxides are random variables introduced during the semiconductor manufacturing process, some variations are generated on the microstructure of the semiconductor chip (for example, at the conductive vias of the PUF structure). Such variations are unpredictable and uncontrollable, thus unable to reproduce the conductive vias with the same microstructure, thereby function as the physically unclonable features. Therefore, in addition to variations in the composition, the content, and the topology of the oxide at the top portion and the bottom portion of the conductive vias themselves, the oxide at all the top portions (or all the bottom portions) of the conductive vias in different PUF structures of the semiconductor chip 8 may also vary in the content and the topology. For example, the oxide at the top portion of the conductive via 851 and the conductive via 852 may have different content and topology, and the oxide at the bottom portion of the conductive via 851 and the conductive via 852 may have different content and topology. This results in the variation of the resistance of the PUF structure 81 and the PUF structure 82.

Based on the above, the semiconductor device with the PUF structure and the semiconductor chip manufactured therefrom in the present disclosure have many advantages. For example, in some embodiments, the first conductive layer and the second conductive layer of the PUF structure may be partially manufactured using the metal layers in the interconnection structure S_{IC}. The logical values “0” and “1” determined from the PUF structures are permanently present and do not require charging for determination, unlike conventional PUF implementations using SRAM, which require charging each time to determine “0” and “1.” Therefore, the semiconductor device and the semiconductor chip manufactured in the embodiments may have an energy-saving PUF hardware security technology. Moreover, the determination speed of the logical values of the PUF structure of the embodiments is very fast, requiring only the electronic elements (such as the transistors) to detect the current of the PUF structure for rapid determination, thereby enabling energy-efficient and environmentally friendly green manufacturing processes.

Moreover, the PUF structure may be manufactured together with the interconnection structure, without performing additional processing steps through new masks, in some embodiments. Therefore, the PUF structure may be readily combined and integrated with existing manufacturing processes without additional semiconductor steps or chemical waste discharge. The manufacturing cost may be saved, and the green process can be implemented. Moreover, the PUF structure of the embodiments is manufactured over the electronic elements, for example, in the interconnection structure. During the wafer-level process, the bottom metal line (for example, the first conductive layer) of the PUF structure may span across the scribe line region. Therefore, the PUF structure of the embodiments does not occupy additional space from the substrate 10, and it is also unnecessary to increase the chip size, thereby facilitating device scaling.

Furthermore, additional current path may be provided in area of the interconnection structure where the PUF structure is absent, by increasing the quantity of the conductive vias and arranging the conductive vias in parallel, according to some embodiments of the present disclosure. The resistance may be reduced, and functions other than the PUF may be enabled. Alternatively, when the length of the first conductive layer is insufficient, it may be difficult to induce the generation of oxides at the conductive vias during the wafer-level process. Therefore, the oxide defects may be eliminated by shortening the metal line (for example, the first conductive layer), thereby reducing the resistance of the conductive vias. Either increasing the quantity of the conductive vias or shortening the metal line can be completed within existing process steps without additional processing. Therefore, the PUF structure may be readily combined and integrated with existing manufacturing processes. The manufacturing cost may be saved, and the green process can be implemented.

What is claimed is:

1. A semiconductor device with a physical unclonable function, comprising:
a substrate;
a physical unclonable function (PUF) structure, comprising:
a first conductive layer over the substrate;
an insulating layer on the first conductive layer;
a second conductive layer on the insulating layer; and
a conductive via penetrating the insulating layer and connecting the second conductive layer and the first conductive layer; and
a logic circuit configured to determine a logical value of the PUF structure and operate the logical value to generate a random number.

2. The semiconductor device of claim 1, wherein the first conductive layer constitutes a conductive line, and the second conductive layer constitutes a pad.

3. The semiconductor device of claim 1, wherein a side edge of the first conductive layer and a side edge of the substrate are coplanar.

4. The semiconductor device of claim 3, wherein the second conductive layer and a side edge of the substrate are spaced apart by a distance.

5. The semiconductor device of claim 1, wherein the conductive via comprising:
a bottom portion on the first conductive layer; and
a top portion, wherein the second conductive layer is on the top portion,
wherein at least one of the bottom portion and the top portion of the conductive via comprises an oxide.

6. The semiconductor device of claim 5, wherein the bottom portion of the conductive via comprises a first oxide, and the top portion of the conductive via comprises a second oxide, wherein materials of the first oxide are different from materials of the second oxide.

7. The semiconductor device of claim 1, wherein the semiconductor device comprises a plurality of the PUF structures, and a plurality of the conductive vias of the PUF structures are configured into a matrix array.

8. The semiconductor device of claim 7, wherein the PUF structures are located in peripheral region outside a memory region.

9. The semiconductor device of claim 7, wherein at least two of the PUF structures have different resistance.

10. The semiconductor device of claim 7, wherein the logic circuit comprising:
a logic determination circuit coupled with the PUF structures to determine logical values of the PUF structures; and
a logic operation circuit coupled to the logic determination circuit to operate the logical values and generate the random number based on an operating result of the logical values.

11. The semiconductor device of claim 1, wherein the semiconductor device comprises a plurality of the PUF structures respectively in die regions, and two ends of the first conductive layer of each PUF structure are in neighboring two of the die regions, respectively.

12. The semiconductor device of claim 11, wherein the first conductive layer of each PUF structure spans across a scribe line region located between the die regions.

13. The semiconductor device of claim 11, wherein the second conductive layer of each PUF structure is only located in a corresponding one of the die regions.

14. The semiconductor device of claim 11, wherein at least two of the PUF structures have different resistance.

15. The semiconductor device of claim 1, wherein the first conductive layer is a portion of a metal layer of an interconnection structure.

16. The semiconductor device of claim 1, wherein the first conductive layer comprising:
a first end portion in a first die region and connected to the second conductive layer through the conductive via in the first die region; and
a second end portion in a second die region adjacent to the first die region.

17. The semiconductor device of claim 1, wherein the logic circuit comprises an electronic element on the substrate and electrically connected to the first conductive layer and the second conductive layer, wherein the electronic element is configured to determine the logical value of the PUF structure comprising the first conductive layer.

18. The semiconductor device of claim 1, wherein the PUF structure comprises a plurality of the conductive vias in a peripheral region outside a memory region.

19. The semiconductor device of claim 12, wherein the logic circuit comprises an electronic element on the substrate and electrically connected to the first conductive layer and the second conductive layer, wherein the electronic element is configured to determine the logical value of the PUF structure comprising the first conductive layer.
